(19) United States
(12) Patent Application Publication
(10) Pub. No.: US 2006/0251301 A1
(43) Pub. Date: Nov. 9, 2006

(54) Method and apparatus for determining correlation between spatial coordinates in breast

(76) Inventors: Michael P. McNamara JR., Parma, OH (US); Steven H. Izen, Shaker Heights, OH (US); David P. Rohler, University Heights, OH (US)

Correspondence Address: CALFEE HALTER & GRISWOLD, LLP, 800 SUPERIOR AVENUE, SUITE 1400, CLEVELAND, OH, 44114, US

(21) Appl. No.: 11/265,538

(22) Filed: Nov. 2, 2005

Related U.S. Application Data
(60) Provisional application No. 60/624,349, filed on Nov. 2, 2004.

(51) Int. Cl. G06K 9/00

(52) U.S. Cl. 382/128

(57) ABSTRACT

Methods and apparatuses using a known location of an item of interest of a breast, such as a lesion, from a method of evaluation to predict the location of the item for another method of evaluation are provided.

### CROSS REFERENCE TO RELATED APPLICATION

The present application claims the benefit of U.S. Provisional Application No. 60/624,349 filed Nov. 2, 2004, the disclosure of which is incorporated herein by reference in its entirety.

### STATEMENT REGARDING FEDERALLY SPONSORED RESEARCH OR DEVELOPMENT

This work was supported, at least in part, by a Department of Defense Congressionally Directed Medical Research Program Concept Award Grant (Grant No. BC032942). The U.S. Government may have certain rights in this invention.

### FIELD

Applicants' inventive concept relates generally to medical imaging and, more specifically, to methods and devices for predicting the spatial coordinates of an anatomic structure or point of interest in or on a breast to be found on one method of evaluation based on information on the location of the item of interest determined from another method of evaluation.

### BACKGROUND

Physical examination and breast imaging are important to breast health. In addition to breast self-examination (BSE) and clinical breast examination (CBE)—inspection and manual palpation of the breast which is performed by physicians and other medical caregivers—many imaging modalities are used to identify and evaluate breast lumps and tissues such as tumors, cysts, and other abnormalities (“lesions”) and to help differentiate benign (noncancerous) and malignant (cancerous) breast disease.

CBE is challenging to learn, and then accurately perform, since on palpation the breast is normally non-uniform (“lumpy-bumpy”) in texture. Furthermore, abnormalities, when present, may be subtle and difficult for the examiner's fingers to distinguish from adjacent normal tissue. Hence, imaging modalities have become vital to patient care and wellbeing. Conversely, definite pathological abnormalities detected on physical examination may be difficult to see or appreciate with one or more imaging modalities. Furthermore, even if an abnormality is seen on one image of one or more of the modalities, it may be difficult to detect or appreciate on another image of the same or a different imaging modality.

Mammography, ultrasound and magnetic resonance imaging (MRI) are imaging modalities commonly used to search for and evaluate breast tissue abnormalities. Mammography and ultrasound are the imaging modalities most commonly employed to non-invasively evaluate the breast. MRI is generally used for further investigation, if warranted. Mammography may be deemed “Diagnostic” when it is used to evaluate a patient who has symptoms, signs or a history of breast disease or “Screening” when the technique is applied as a cancer surveillance examination for the general population of women who are asymptomatic. Ultrasound is rarely used for screening and generally reserved for further evaluation of breast abnormalities detected on mammography and physical examination.

If an abnormality is identified on physical examination and/or using one of these imaging modalities, it is common to examine the patient with another of the imaging modalities to clarify any ambiguous finding and achieve greater accuracy and completeness in diagnosis.

The breast is very pliable and its geometry, as a whole, responds to the effects of gravity and other external forces imparted during examination.

SBE and CBE are performed with the patient both upright and supine, with the examining fingers trapping breast tissue between skin and chest wall as lumps are sought. As a result, the breast tissue is displaced toward and against the chest wall and the skin at the site of examination is oriented generally parallel to the chest wall.

Conversely, during a mammogram, the majority of the skin and underlying breast is displaced away from the chest wall and flattened into a plane which is perpendicular to the chest wall.

Mammography is a specific type of imaging that uses a low-dose X-ray system for the examination of breasts. As currently clinically practiced, during a mammography exam, the patient is typically upright and the technique entails pulling one breast at a time away from the body and resting it on the surface of a plate with another plate pressed firmly against opposite side of the breast to hold and flatten out the breast tissue. Breast compression during mammography spreads out the tissue which minimizes and evens out the thickness. This compression is important because it improves overall visualization of the tissue and lessens the chance that abnormalities are obscured by overlying breast tissue. Compression also holds the breast still to eliminate blurring of the image caused by motion and reduces X-ray scatter to increase sharpness of the image. X-rays passing through the breast tissue are detected and processed into an image for display on film or a monitor (an electronic viewing device such as, for example, a cathode ray tube (CRT), liquid crystal display (LCD) or plasma monitor). The resultant image or “view” is a two dimensional representation of the complex three dimensional structure of the breast.

The Cranio-Caudal (CC) view and a Mediolateral Oblique (MLO) view are two views that are commonly used in mammography. Other views used in mammography include a Latero-Medial (LM) view, a Mediolateral (ML) view, etc.

The CC view, or head-to-toe view, images the breast from above. A CC view of a right breast is illustrated in FIG. 1A and a CC view of a left breast is illustrated in FIG. 1B. The MLO view images the breast from a side-to-side perspective at an oblique angle. An MLO view of the right breast is illustrated in FIG. 1C and an MLO view of the left breast is illustrated in FIG. 1D.

On mammography, the location of a lesion or site of interest can be described in many ways including a rough, intuitive estimation of clock-face, the quadrant, and approximate depth (expressed as anterior, middle or posterior breast). It is not uncommon for examiners to have difficulty describing the exact location of the mammographic abnormality. In addition to having to integrate information from two separate views, estimation of lesion location is challenging since the CC views and the MLO views are not at 90 degrees with respect to each other and the angle at which the MLO views are done is quite variable (generally between about 30 and 60 degrees; the technologist tries to conform to the lateral edge of the pectoralis muscles). Thus, an estimate of the clock face position, or even the quadrant in which the lesion resides, will also be affected by MLO angle, particularly when the lesion is closer to the periphery of the breast near the 12:00-6:00 axis or the 3:00-9:00 axis. A lesion seen on one view of the breast may be occult on another view. The best clinical description, derived from experience and intuition, is an estimate of clock-face position and depth (anterior, middle or posterior breast).

In addition to the difficulties in predicting where a mammographic lesion will be found on ultrasound or physical examination, similar difficulties arise when trying to predict where a lesion seen on ultrasound or on physical exam will be on the mammogram.

Breast ultrasound is typically done with the patient supine (laying on her back) using a hand-held probe (ultrasound transducer) which is in contact with the skin surface and oriented in a fashion to be perpendicular or roughly perpendicular to the chest wall. Optimal sonographic technique requires compression to be applied; but, as with physical examination, the pressure is directed between skin and chest wall wherein the site of interest is trapped as it is acoustically examined. The typical ultrasound display is thus a two dimensional image directed toward the chest wall. At least two orthogonal images are done of the site of interest: longitudinal and transverse (“north/south” and “side to side”, respectively) with respect to the long axis of the body or radial and anti-radial with respect to the nipple. Various descriptions (annotations) of the location of the site being imaged have been deemed clinically acceptable, for example, describing the lesion according to the quadrant it is in, the clock-face position, or a combination of clock-face position and distance from the nipple. The most informative description is clock-face position and distance from the nipple, but there is variation clinically in how these measurements are done (e.g., as patients may be positioned supine or in a variation of supine).

An MRI of a breast is generally performed with the patient in a prone position and the breast oriented and hanging dependently within the well of a breast coil. MRI uses radiofrequency waves and a strong magnetic field rather than X-rays to provide detailed images of internal organs and tissues. The technique has proven very valuable for the diagnosis of a broad range of pathologic conditions in all parts of the body including cancer, heart and vascular disease, stroke, and joint and musculoskeletal disorders. MRI requires specialized equipment and expertise and allows evaluation of some body structures that may not be as visible with other imaging methods. MRI of the breast is becoming important for many clinical indications including characterization of indeterminate lesions, the extent of disease, search of occult disease in patients with malignant adenopathy, surveillance of patients at high risk, etc. The MRI data can be used to produce volume and planar images, the latter in any orientation to the body. As with the other imaging modalities, the location of a lesion can be described in various ways.

Assignment of lesion location is dependent on the training, skill and experience of the examiner(s).

Close correlation of location of a lesion found on physical examination and ultrasound is possible if the lesion can be definitely and unequivocally identified and the patient is similarly positioned for the examinations and careful measurement of clock-face position and distance from the nipple are done.

However, equating lesion location estimates between the physical examination and mammography and ultrasound and mammography is, in general, difficult to perform and prone to error because of the considerable differences in patient positioning, direction of compression and the individual exam techniques noted above. Accurate location estimates that can be equated to ultrasound and physical examination are difficult to achieve and are even more dependent on the experience and expertise of the radiology physician reading the examination.

From a practical standpoint, it can be difficult to intuitively predict the location where a lesion detected on mammography or ultrasound will be found on a subsequent MRI. Conversely, it is not uncommon to have one or more unexpected findings on an MRI, which then require reappraisal of the patient's mammograms and/or a return to the ultrasound suite to attempt to determine the significance of the unexpected MRI findings.

Excellence in patient care requires that there be complete concordance between any and all of the modalities used to examine the patient, to ensure that it is truly the same abnormality that is being identified and evaluated on the studies.

In general day to day clinical practice, when mammography is used, it is often difficult to predict the location where a discovered abnormality will be found using another modality (e.g., ultrasound or physical examination), or, conversely, where it must be found on mammography because of the type of views which are commonly used in mammography.

Thus, a need exists for readily predicting the location of an item of interest (e.g., a lesion) for one modality, including physical examination, based upon where the item of interest is noted by another means of evaluation.

### SUMMARY

Accordingly, it is one aspect to provide a method and system for predicting the location of an object of interest in or on a breast applicable to one method of evaluation from data on the location of the object of interest determined using another method of evaluation.

It is another aspect to provide a method and apparatus for predicting the location of an object of interest in or on a breast on an ultrasound and/or physical examination from data on the location of the object of interest determined by mammography of the breast.

It is still another aspect to provide a method and apparatus for predicting the location of an object of interest in or on a breast on a mammogram from data on the location of the object of interest determined by an ultrasound and/or physical examination of the breast.

It is yet another aspect to provide a method and apparatus for predicting the location of an object of interest in or on a breast on a mammogram, ultrasound and/or physical examination from data on the location of the object of interest determined by an MRI of the breast.

It is an aspect to define a standard position for a patient to assume when examiners perform ultrasound (or when SBE or CBE are done with the patient lying down) in order to reduce lateral displacement of the breast during examination so as to facilitate examination and minimize variation in technique and measurement.

It is another aspect to provide a method and apparatus for predicting the location of an object of interest in or on a breast on a mammogram view from data on the location of the object of interest determined from another mammogram view. Accordingly, if two views of a breast are imaged by mammography and a lesion only appears in one of the views, a region containing the location of the lesion on the other view can be estimated.

It is still another aspect to designate visually, as with a graphical overlay, an estimated location, for example, on a mammogram, on an image of the breast in the standard position, etc.

It is another aspect to correct spatial registration anomalies between prior and subsequent congruent mammogram views.

It is an aspect to provide a tool for teaching and improving image interpretation and physical examination skills.

### DESCRIPTION OF THE DRAWINGS

The above and additional aspects, features and advantages will become more apparent by describing in detail exemplary embodiments with reference to the attached drawings, in which:

FIG. 1A is a drawing illustrating a CC view of a right breast;

FIG. 1B is a drawing illustrating a CC view of a left breast;

FIG. 1C is a drawing illustrating an MLO view of the right breast;

FIG. 1D is a drawing illustrating an MLO view of the left breast;

FIG. 2 is a flowchart illustrating a method for predicting a location to assist in performing an ultrasound from known mammogram data, according to an exemplary embodiment;

FIG. 3A is a drawing illustrating a CC view of a left breast having a lesion therein;

FIG. 3B is a drawing illustrating an MLO view of the left breast having the lesion therein;

FIG. 4 is a photograph illustrating an exemplary mammography machine capable of rotating an image plane about two independent axes;

FIG. 5A is a photograph showing a perspective view of a patient in a supine position;

FIG. 5B is a photograph showing a perspective view of the patient in a standard position;

FIG. 6A is a drawing illustrating a top view of a left breast of a patient in the standard position with a predicted location marked thereon;

FIG. 6B is a drawing illustrating a side view of the left breast of the patient in the standard position, as viewed from the patient's feet looking toward the patient's head, with a predicted depth shown thereon;

FIG. 7 is a drawing illustrating another top view of the left breast of the patient in the standard position with the predicted location marked thereon;

FIG. 8A is a drawing illustrating a top view of a left breast of a patient in the standard position having a lesion therein;

FIG. 8B is a drawing illustrating a side view of a left breast of a patient in the standard position, as viewed from the patient's feet looking toward the patient's head, having a lesion therein;

FIG. 9 is a drawing illustrating a CC view of the left breast of the patient having the predicted location of the lesion marked thereon;

FIG. 10 is a graph illustrating the correlation between predicted and measured clock-face position of a lesion for a sample set of patients, according to an exemplary embodiment; and

FIG. 11 is a graph illustrating the correlation between predicted and measured distance from the nipple to the lesion for the sample set of patients, according to an exemplary embodiment.

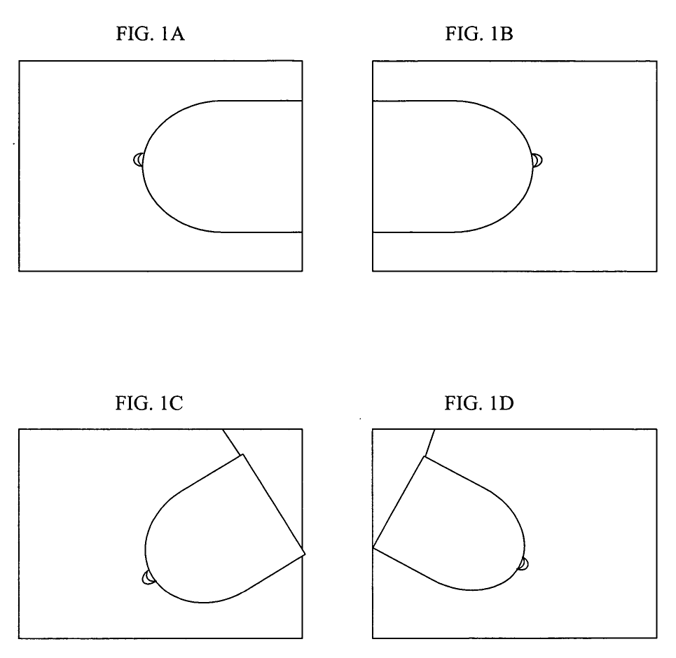

### DESCRIPTION OF EXEMPLARY EMBODIMENTS

Hereinafter, exemplary embodiments will be described in detail with reference to the accompanying drawings. The exemplary methods and systems described herein allow for the estimation of the location of an item of interest for use in performing mammography, ultrasound, MRI or physical examination of a breast, given a known position of the item from performing at least one of the other modalities. The estimated location can be, for example, a point, a line, a curve, a surface, a region, etc.

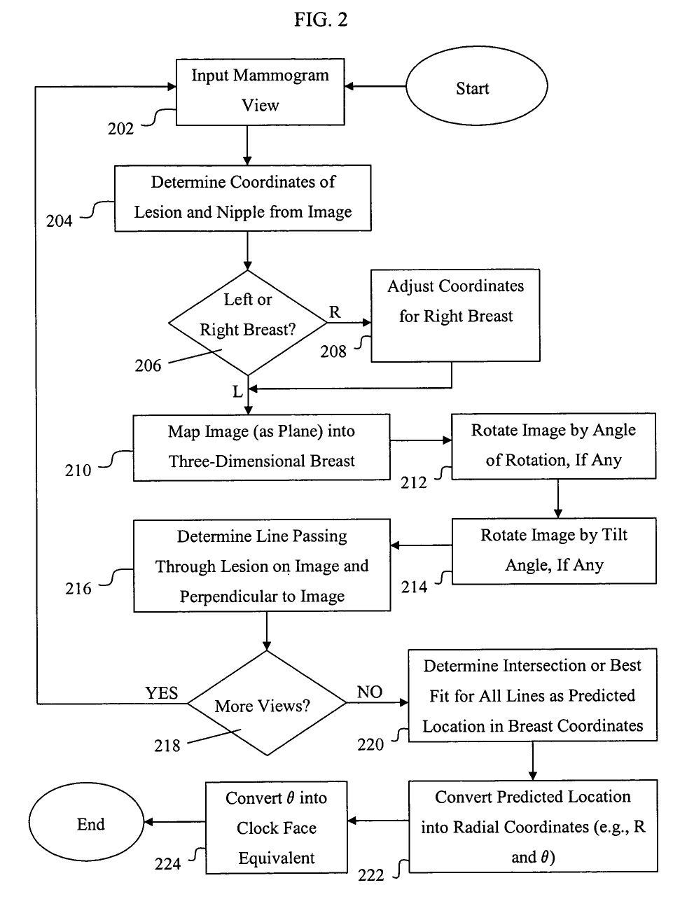

By way of example and not by way of limitation, an exemplary embodiment directed to a method for predicting the location of an item an interest (e.g., a lesion) of a breast for use in performing an ultrasound, given known location information of the lesion from two mammograms will be described herein with reference to FIG. 2.

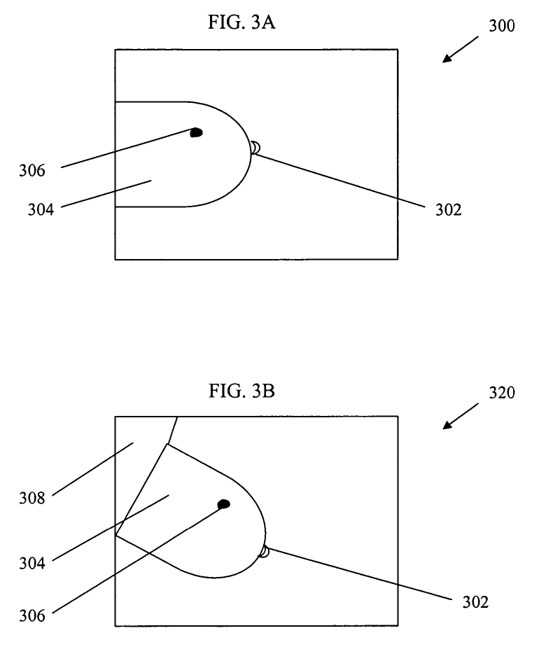

Preferably, but not necessarily, at least two views of a breast being examined are provided (steps 202, 206 and 218), with the lesion being visible on each of the mammograms. For example, as shown in FIG. 3A, a mammogram 300 representing a CC view of a left breast 304 and nipple 302 illustrates a lesion 306 within the breast. In FIG. 3B, the lesion 306 appears in a mammogram 320 representing an MLO view of the left breast 304, nipple 302 and chest wall 308.

Mammograms 300 and 320 can be produced, for example, with screen-film cassettes that are exposed to X-rays during mammography. In such a case, the data on the mammograms 300 and 320 is preferably, but not necessarily, digitized. In this manner, the data derived from the mammograms 300 and 320, which represents the images from the respective films, can be readily stored, transmitted and processed.

Such digitization is unnecessary if the mammograms 300 and 320 are produced by digital mammography, wherein the X-rays passing through the compressed breast are recorded by means of an electronic digital detector instead of the film. In digital mammography, the resulting electronic image can be, for example, displayed on a monitor and/or printed onto film.

For mammogram 300 (i.e., the CC view of the breast), an angle of rotation of the developed image with respect to the left breast 304 is known, as is a tilt angle of the left breast 304 in the developed image. For example, the angle of rotation and tilt angle are known based on the positions of an axis of rotation and a tilt axis, respectively, of the mammography machine at the time the mammogram 300 is taken.

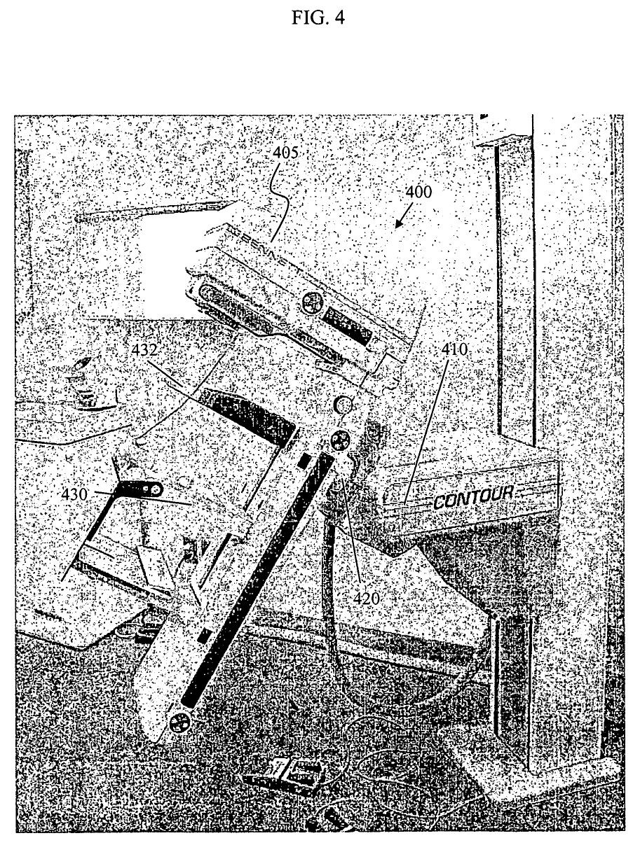

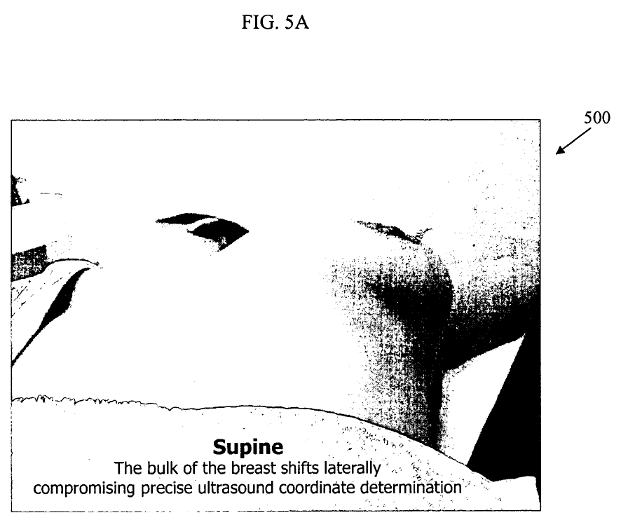

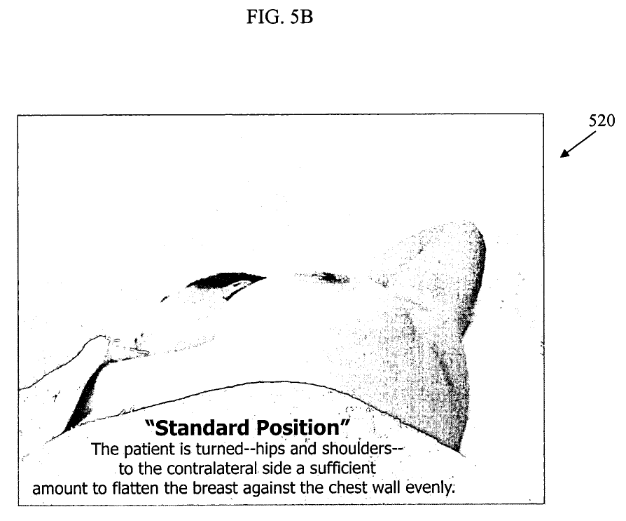

An illustrative mammography machine 400 having an X-ray emitter 405, as shown in FIG. 4, includes an axis of rotation 410 and a tilt axis 420. As some mammography machines lack a tilt axis, a mammogram taken by such a machine will not have a tilt component. In an exemplary embodiment, a mammogram view from a machine lacking a tilt axis is treated as having a tilt value of 0. Other information may be known from the state of the mammography machine 400 at the time a mammogram is taken. For example, the amount of compression is known from the distance between a first plate 430 and second plate 432 between which the breast being examined is compressed.

Additionally, the physical size (i.e., the width and height) of the scanned CC image (e.g., in millimeters), as well as the pixel dimensions (e.g., 3600×4800 pixels) of the scanned CC image are known. Furthermore, a location of the nipple 302 and a location of the lesion 306 are determined from the mammogram 300, e.g., from data derived from the mammogram 300 (step 204).

For example, x and y coordinates of the nipple 302 (e.g., in image pixels) are determined, as are x and y coordinates of the lesion 306 (e.g., in image pixels). The coordinates of the nipple 302 and the lesion 306 may be determined, for example, manually by a technician (e.g., a radiologist or clinician). Alternatively, image processing techniques may be able to identify the nipple 302 and/or lesion 306 in a mammogram so as to determine the corresponding coordinates. In an exemplary embodiment, an image processing technique for identifying the nipple 302 and/or lesion 306 in a mammogram uses information on contour of the breast 304.

Additional devices may be used to aid in identifying the nipple 302 and/or the lesion 306 in the mammogram 300. For example, a metal ball may be placed near the center of the nipple 302 prior to performing mammography on the breast. Furthermore, a hook-wire may be used to skewer the lesion 306 to highlight the lesion on the mammogram and to assist in confirming the identification of the lesion among different views. Other techniques which may be useful include needle localization and skin mapping.

Similar information is known and/or determined for mammogram 320 (i.e., the MLO view of the breast). Based on the known position information of the lesion 306 in the mammograms 300 and 320, a predicted location of the lesion 306 for an ultrasound examination is determined.

In an ultrasound examination, a probe containing one or more acoustic transducers sends pulses of sound into the breast. In general, whenever a sound wave encounters a material with a different acoustical impedance, part of the sound wave is reflected, which the probe detects as an echo. The time it takes for the echo to travel back to the probe is measured and used to calculate the depth of the tissue causing the echo.

It has been a common practice for both clinical practitioners conducting physical examination and imagers performing ultrasound of the breast to study the recumbent patient supine, i.e., flat on the back, with the ipsilateral arm in a variable amount of extension (see, e.g., FIG. 5A). Additionally, in an attempt to increase the sensitivity of the exam by “thinning” the part of the breast being examined the patient may be turned a variable amount to the ipsilateral or contralateral side by displacing the bulk of the remainder of the breast. Although aspects of this approach have merit, the inherent variability of positioning and overall technique combined with the mobility and plasticity of the breast makes it difficult or impossible to either assign or predict the location of lesion with consistency and accuracy. Simply put, this shifting of the breast makes predicting the location where the sonographer should search for a lesion 306, known to be present mammographically or with MRI, with the ultrasound transducer more difficult. Conversely, the variability of positioning and the displacements of the breast that occur this method of breast examination deter assignment of unique spatial coordinates that can be related to lesion location on mammography and MRI.

Accordingly, a standard position is defined herein for positioning the patient during both clinical and ultrasound examination.

The standard position (see, e.g., FIG. 5B) is a variation of supine in which the patient is turned to the contralateral side (hips and shoulders uniformly) a sufficient amount to flatten the breast evenly against the chest wall in the ML direction (side to side). Furthermore, the patient's arm is abducted a sufficient amount to flatten the tail of the breast against the chest wall as well. In most patients, with these maneuvers, the superior and inferior portions of the breast will also be evenly displaced on the chest wall. However, occasionally, patients have a “bell-shaped” chest (i.e., the caudal aspect of the thorax slopes more anteriorly than usual) which results in a tendency for the bulk of breast to shift asymmetrically superiorly whenever the patient is recumbent. In this circumstance, to fully achieve the standard position, the head of the examining table may need to be elevated (to some degree of Fowler's position) or the entire table itself placed in reverse Trandelenburg's position a sufficient amount to make the anterior chest wall more parallel to the floor so gravity can shift the breast away from the head and towards the feet a sufficient amount so that the superior and inferior portions of the breast are also distributed evenly on the chest wall. To facilitate stability of positioning and patient comfort, support may be placed under the arm and ipsilateral aspect of the chest, abdomen and hip.

When the patient is in the standard position the nipple areolar complex is centered with the bulk of the remainder of the breast evenly distributed about it, in the medial, lateral, superior, and inferior directions. Achieving the patient standard position is easy, since the examiner merely needs to maneuver the patient until the nipple-areolar complex is centered on the bulk of the breast.

An intent of the standard position is a symmetrical and reproducible displacement of the breast when the patient is recumbent, so that it is evenly distributed upon the chest wall for either physical or ultrasound examination. The result of the standard position is that measurement of lesion location (e.g., clock-face position and distance from the nipple) can be done and reported in the same fashion with CBE and ultrasound, and the results of one of these exams can easily be correlated with the other.

As shown in FIG. 5, the breast of a patient in the supine position 500 has shifted laterally. Conversely, the breast of the patient in the standard position 520 is substantially flat again the chest all, with minimal lateral shifting. Accordingly, with the patient in this standard position, a sonographer can easily and accurately ascertain the position on the breast for the ultrasound to be performed, based on the predicted location.

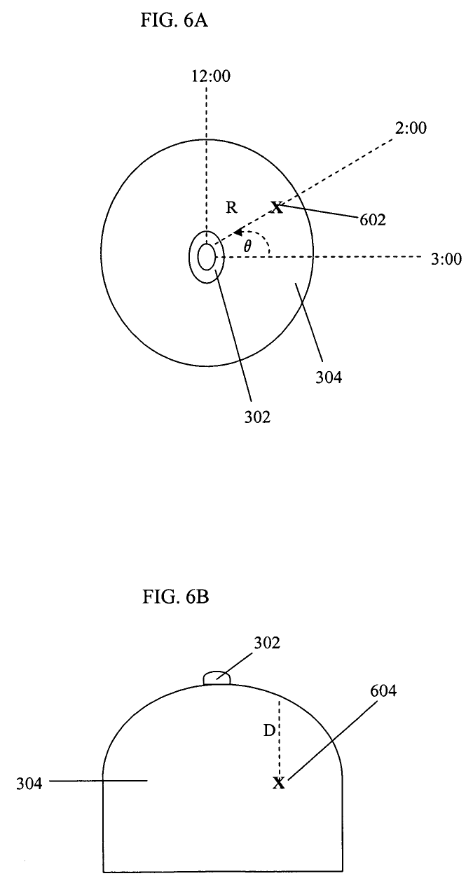

The information on the location of the lesion 306 to be predicted for use in the ultrasound examination includes R, which is the radius (distance) of the lesion 306 from the nipple 302 (in centimeters), θ, which is the angular location of the lesion 306 (e.g., in degrees), and D, which is the depth of the lesion 306 from the skin surface (in millimeters). For example, in FIGS. 6A and 6B, the predicted location on a left breast 304 of a patient in the standard position to search for the lesion 306 via ultrasound is marked by an “X” 602, corresponding to a radius R and an angle θ of approximately 30 degrees (i.e., approximately the 2:00 clock face position), and an “X” 604 corresponding to a depth D.

The R and θ values alone may be sufficient to identify a predicted location of the lesion (i.e., a point (x,y)) for use in performing an ultrasound. As polar coordinates (R, θ), R is the radial distance from the origin (e.g., the nipple) to the point (x,y) and θ is the polar angle measured as the angle counterclockwise from the positive x-axis (i.e., the 3:00 clock face position) to the line from the origin to the point (x,y).

With respect to a location on the breast, however, it is common for clinicians to use a clock face position instead of θ. A clock face position is an angular measurement, measured in hours, in the clockwise direction, from the 12:00 position (i.e., the positive y-axis). For example, a clock face position of 7:00 corresponds to an angle of 240 degrees. As a practical matter, a θ value may be readily converted to a clock face position and vice versa.

In addition to the R and θ values, the ultrasound itself may then determine the D value. Accordingly, in this exemplary embodiment, only the R and θ values are predicted based on the information known from mammograms 300 and 320, as follows. In other exemplary embodiments, the D value could be predicted as well.

For each of mammograms 300 and 320 (i.e., the CC and MLO views of the left breast 304), the position of the lesion 306 with respect to the lower left corner of the image (e.g., based on the data derived from the mammograms 300 and 320) is computed (step 204). Additionally, the position of the nipple 302 with respect to the lower left corner of the image is computed (step 204). Such positions are referred to as “film coordinates” or “image coordinates.”

A line corresponding to the chest wall 308 is estimated. In this exemplary embodiment, the left edge of the image (i.e., the left edge of mammograms 300 and 320) is estimated to be the line (i.e., the chest wall 308). In other exemplary embodiments, the line could be estimated by image processing or based on information provided by, for example, the radiologist. In a two-dimensional coordinate system where the nipple 302 represents the origin, unit vectors perpendicular to the line representing the chest wall 308 head to the right side of the image and unit vectors parallel to the line representing the chest wall 308 head to the top of the image, the location of the lesion 306 with respect to the nipple 302 is computed.

In a three-dimensional coordinate system where the nipple 302 represents the origin, the axes are perpendicular to the standard body cross-sectional (i.e., axial/transverse, sagittal and coronal) directions. Coordinates in this coordinate system are referred to as “body coordinates” or “breast coordinates.”

The image (e.g., based on the data derived from the respective mammogram 300, 320) as a plane is located in three-dimensional space as an axial slice, with the nipple 302 in the image corresponding to the nipple in body coordinates, to form an initial location of the image plane (step 210). Then, the image plane is rotated about an axis perpendicular to a coronal slice by the angle of rotation known for the respective mammogram 300, 320 (step 212).

Thereafter, the image plane is rotated about an axis perpendicular to a sagittal slice by the tilt angle, if any, known for the respective mammogram 300, 320 (step 214). The lesion location on the image plane after this rotation is now in breast coordinates. Accordingly, the angle of rotation and the tilt angle known from the mammograms 300 and 320 are accounted for by mathematically transforming the spatial coordinates representing the image plane.

In this exemplary embodiment, angle of rotation is addressed before tilt angle, because of the manner in which the mammograms 300, 320 were produced (e.g., by mammography machine 400). In other exemplary embodiments, it may be necessary to address the tilt angle before the angle of rotation.

Then, the line passing through the lesion location on the image plane and perpendicular to the image plane is computed, in breast coordinates (step 216). This line represents a backprojection of the locations within the three-dimensional left breast 304 at which the lesion 306 could have been located to result in the marking at the known location in the two-dimensional image (i.e., mammograms 300, 320).

With the line passing through the lesion location on the image plane and perpendicular to the image plane computed for each of the mammogram views, as described above, the intersection of the lines is then computed in a lesion localization process (step 220). In an exemplary embodiment, the lesion localization process includes backprojecting multiple lines (corresponding to multiple views) to aid in predicting the location of the lesion, for example, for an ultrasound modality. Other exemplary embodiments may incorporate mathematical breast compression models in the lesion localization process.

In practice, the lines will often not intersect. In such a case, the best “fit” for the intersection is computed (step 220). According to an exemplary embodiment, a least squares fit for the intersection point of the lines is performed. The intersection point of the lines or the best “fit” for the intersection of the lines represents the predicted location of the lesion in breast coordinates. In another exemplary embodiment, the best “fit” is achieved through iterative calculations that are used to minimize an error measure.

In other exemplary embodiments, the set of points which may have given rise to the location identified on the mammogram image can be curves or regions instead of lines. The shape of the curves or regions can be deduced, for example, from physical characteristics of the breast (e.g., breast density) and the amount of compression used when acquiring the mammogram.

Thereafter, the predicted location of the lesion in breast coordinates is projected into coordinates useful for performing an ultrasound evaluation. In this exemplary embodiment, ultrasound coordinates R and θ are defined by polar coordinates in the coronal plane (step 222). The polar angle defined by θ can be converted into a clock face reading to be used for the ultrasound (step 224).

By using the known pixel dimensions and physical size of the image (i.e., mammograms 300, 320), it is possible to convert from pixel units to physical (e.g., millimeter and/or centimeter) units. Accordingly, the predicted lesion location can be presented in physical ultrasound coordinates.

In other exemplary embodiments, the D coordinate may be defined in the direction orthogonal to the R/θ plane. In still other exemplary embodiments, physical characteristics of the breast (e.g., size, tissue density, location of the chest wall, etc.) may be taken into account when projecting the breast coordinates into the ultrasound coordinates.

According to this exemplary embodiment, the method is applicable to the right breast as well, with minor modifications (step 208). For example, the right breast is handled by transforming to the geometry of the left breast and then using the left breast geometry. In an exemplary embodiment, this is accomplished by measuring image coordinates from the upper right corner of the image (as opposed to the lower left corner of the image), and by reversing the sign of the angle of rotation.

In another exemplary embodiment, the predicted location is used to aid in performing a physical examination of the breast. Preferably, but not necessarily, the physical examination is performed while the patient is in the standard position. For the physical examination, the lesion is expected to be found, if it is palpable, at the same coordinates known from an ultrasound, or predicted from the mammogram data or the MRI data.

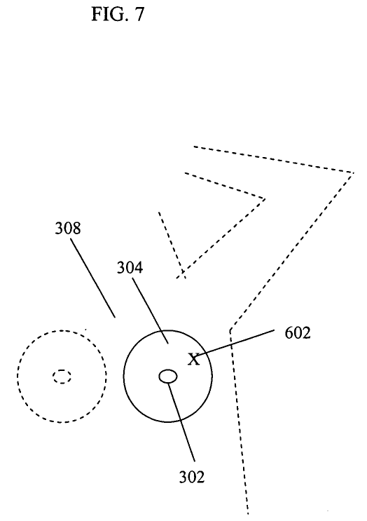

As shown in FIG. 7, the left breast 304 of a patient in the standard position is substantially flat against the patient's chest wall 308. Based on the values of R and θ determined from mammograms 300, 320, the examiner knows the predicted location 602 on the left breast 304 at which to initially focus the examination. If an estimation of D was determined from the mammograms 300, 320 as well, the examiner will also know the predicted depth 604 of the lesion. Use of the standard position, as described above, is particularly advantageous in this instance since compression of the breast in the standard position tends to preserve the θ value.

In a similar fashion, according to another exemplary embodiment, a known ultrasound location of an item of interest can be used to predict a location of the item on a mammogram. Preferably, but not necessarily, the ultrasound is administered with the patient in the standard position.

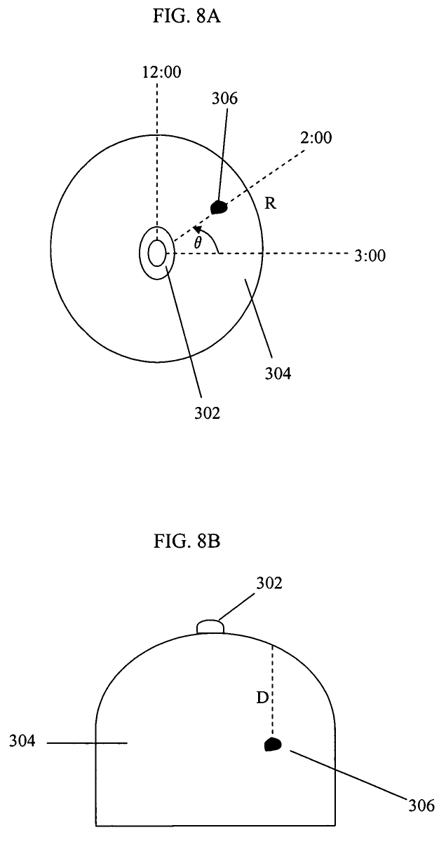

For example, from an ultrasound (e.g., a transverse or longitudinal view) of a left breast 304 having a lesion 306 therein, information on the location of the lesion 306 (e.g., the R and θ values) can be determined. For example, as shown in FIGS. 8A and 8B, an ultrasound of the left breast 304 having the lesion 306 is determined to have an R value, a θ value (corresponding approximately to a clock face position of 2:00) and a D value. The ultrasound may reveal additional information, such as a T value, which is the breast thickness (in millimeters) at the site of the lesion 306.

In another exemplary embodiment, if the lesion 306 is palpable, the values of R, θ and D may be approximated based on a physical examination of the left breast 304, instead of ultrasound. Preferably, but not necessarily, the patient is in the standard position for the physical examination.

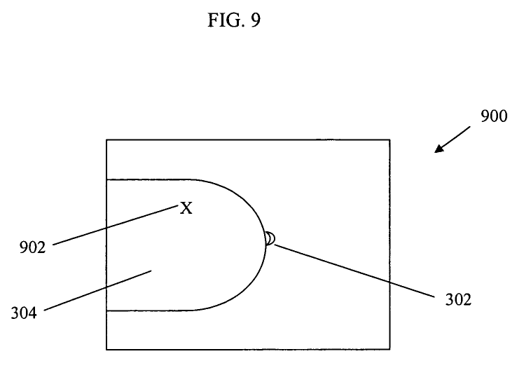

From this known position information, whether from an ultrasound or physical examination, a location 902 of the lesion 306 on a mammogram (e.g., a CC view) 900, as shown in FIG. 9, can be predicted for a specified angle of rotation and tilt angle.

In addition to the angle of rotation and tilt angle for the mammogram, the physical size (i.e., the width and height) and the pixel dimensions (e.g., 3600×4800 pixels) of the desired mammogram must be provided, for example, by operator input.

As noted above, the ultrasound reveals information such as the polar coordinates (R, θ) indicating the position of the lesion 306 with respect to the nipple 302. Preferably, but not necessarily, the lesion position is measured with respect to the nipple 302 with the breast 304 in the standard position.

Other information known from the ultrasound data includes, for example, D, which is the depth of the lesion 306 from the skin surface and D₁, which is the depth of the chest wall. Other exemplary embodiments may use additional known information, such as an amount of compression of the breast 304, the size of the breast 304, the tissue density, etc. in predicting the location of the lesion 306 on the mammogram.

The nipple 302, the lesion 306 and the chest wall 308 are located in body/breast coordinates (i.e., a three-dimensional Cartesian coordinate system), with the nipple 302 considered to be the origin of the breast 304. In an exemplary embodiment, a breast to chest wall direction is the direction perpendicular to the coronal plane, and the chest wall is a coronal plane at a depth given by the nipple 302 to chest wall 308 distance.

The location of the lesion 306 (in a coronal plane passing through the lesion) is indicated by polar coordinates (R, θ) with respect to the nipple 302. The lesion depth D (with respect to the nipple 302) indicates the appropriate coronal slice.

Using the specified angle of rotation and tilt angle, the direction perpendicular to the image plane is computed. With the nipple 302 as the origin, the three-dimensional location of the lesion 306 is projected onto the image plane, as the plane of the mammogram to be estimated. In other exemplary embodiments, alternate methods of incorporating the geometry of the breast could be used to project (e.g., the lesion 306) onto the image plane.

The chest wall 308 is located on the plane of the mammogram as a line, which is the intersection (in three dimensions) of the chest wall plane with the mammogram plane. The angle of this line is determined for the coordinate system, and the distance of this line to the nipple 302 (on the mammogram plane) is computed. Then, the mammogram plane is rotated such that the vertical direction is parallel to the chest wall 308. As noted above, in one exemplary embodiment, a breast to chest wall direction is the direction perpendicular to the coronal plane, and the chest wall is a coronal plane at a depth given by the nipple 302 to chest wall 308 distance.

The coordinates of the lesion with respect to this rotated mammogram plane (e.g., with all distances currently in centimeters) are determined. Optionally, the origin of the rotated coordinate system is shifted.

In an exemplary embodiment, the origin of the coordinate system may be shifted horizontally (with respect to the nipple 302) by the nipple-chest wall distance and vertically by half the height of the desired mammogram. The left edge of the mammogram plane is now coincident with the line on the mammogram plane which represents the chest wall 308, and the vertical position of the nipple 302 is halfway between the top and bottom of the mammogram to be estimated. The origin is now located at the lower left corner of the mammogram to be estimated. The location of the nipple and the lesion are computed in this shifted coordinate system.

From the known physical size and pixel resolution of the mammogram to be estimated, all distances are converted into pixel units. Accordingly, the predicted nipple 302 and lesion 306 locations are now given in image coordinates. Thereafter, the estimated location of the nipple 302 and/or lesion 306 can be presented to a user (e.g., textually, graphically, etc.).

According to another exemplary embodiment, a method (and apparatus for practicing the method) are provided for predicting the location of an object of interest (e.g., a lesion) of a breast for a mammogram, ultrasound and/or physical examination from data on the location of the lesion 306 determined by an MRI on the breast.

As noted above, an MRI is typically performed on a breast with a patient lying down on her stomach (e.g., on a table within the MRI device) such that her breasts hang down due to gravity. The MRI system can identify the locations of the nipple 302 and the lesion 306 in a three-dimensional (breast) coordinate system. Additionally, the MRI system can provide information on other items as well, for example, the chest wall 308, the skin outline, etc.

The steps described above for transforming breast coordinates (e.g., of the nipple 302 and the lesion 306) to coordinates useful for performing an ultrasound or physical examination may be applied to the data from the MRI.

In an exemplary embodiment, this transformation is a projection along lines perpendicular to the coronal plane. A more general model of the transformation of the breast geometry from the MRI position to the standard position could be used. For example, since the breast tissue typically falls directed toward the chest wall 308, a projection modeling this transformation could be used.

In another exemplary embodiment, the locations of the nipple 302 and the lesion 306, as determined in breast coordinates from the MRI data, can be converted into mammogram coordinates, in a manner similar to that described above for predicting a location on a mammogram from ultrasound data.

In yet another exemplary embodiment, if an item of interest (e.g., a lesion) is visible on a first mammogram view but not visible on a second mammogram view, the region in which the item could be expected to be found on the second mammogram view is predicted based on the first mammogram view.

For example, in a first mammogram (e.g., a CC view of the left breast 304), the lesion 306 is detected, but in a second mammogram (e.g., an MLO view of the left breast 304), the lesion 306 is not detected.

A line, curve or region of possible source locations (in breast coordinates) is determined for the detected lesion 306 in the first mammogram. Using the angle of rotation and tilt angle, known from the first mammogram, the location of the chest wall 308 is transformed into a plane, surface or region in three-dimensional space (i.e., in breast coordinates). Accordingly, the region in space which could have projected onto the chest wall 308 is located. In an exemplary embodiment, the left edge of the image is backprojected into a plane in breast coordinates. Thus, the lesion 306 is located as a line in breast coordinates and the chest wall 308 is located as a plane in breast coordinates.

Using the specified angle of rotation and tilt angle for the second mammogram, the direction perpendicular to the image plane is computed.

According to an exemplary embodiment, the chest wall 308 is located on the plane of the second mammogram as a line, which is the intersection (in three dimensions) of the chest wall plane with the plane of the second mammogram. The angle of this line is determined for the coordinate system on the plane of the second mammogram, and the distance of this line to the nipple 302 (on the mammogram plane) is computed. Then, the plane of the second mammogram is rotated such that the vertical direction is parallel to the chest wall plane.

The coordinates of the lesion with respect to this rotated mammogram plane (e.g., with all distances currently in centimeters) are determined. Then, the origin of the rotated coordinate system is shifted horizontally (with respect to the nipple 302) by the nipple-chest wall distance, and vertically by half the height of the desired mammogram. The left edge of the mammogram plane is now coincident with the line on the mammogram plane which represents the chest wall 308, and the vertical position of the nipple 302 is halfway between the top and bottom of the mammogram to be estimated. The origin is now located at the lower left corner of the mammogram to be estimated. The location of the nipple is computed in this shifted coordinate system.

The line (or curve) of possible source locations (in breast coordinates), as determined above, is projected onto the image plane of the second mammogram. In an exemplary embodiment, each point on the line (or curve) is projected as a point (in film coordinates) on the image plane of the second mammogram, thereby yielding a one-parameter family of points for the second mammogram. The estimated locations (region) can be present to the user (e.g., textually, graphically, etc.). For example, the predicted location of the item may be displayed as a graphical overlay on the second mammogram view as an aid in interpreting the second mammogram.

In another exemplary embodiment, an apparatus for predicting the location of an item of interest (e.g., a lesion) of a breast for use in performing an ultrasound, given known location information of the lesion from mammograms (e.g., data derived from a mammogram) is provided. The apparatus may be a device for performing the exemplary methods described above and variations thereof.

As one example, the apparatus includes a computer (e.g., a general purpose computer) for executing a predefined algorithm (computer program) to predict the location of the lesion 306. The computer receives data representing different views (e.g., CC and MLO views) of a breast 304 with the lesion 306 indicated thereon. If digital mammography was not used, the data can be obtained by digitizing films of the two different views.

The location of the lesion 306 for each view is manually input by an operator. Optionally, the computer may be able to process the data to identify the location of the lesion in each of the views. For example, the operator could identify the lesion 306 for a view displayed on the computer (e.g., by using a mouse to click on the lesion). Thereafter, the computer could determine the image coordinates of the lesion 306 based on the location that the operator clicked and the known image and/or pixel dimensions.

As another example, the computer could employ image processing to process the mammographic data in order to identify the lesion 306 for each view. This image processing could use information on the contour of the breast 304.

Thereafter, according to an exemplary embodiment, the aforementioned lesion localization process is used by the computer to locate the identified lesion locations onto regions in three-dimensional space, wherein the regions represent the points in the breast through which the probing X-rays have passed.

By computing the intersection, or the likely region for the intersection, the computer determines the likely location of the lesion in three-dimensional space. The computer then transforms the three-dimensional region to the geometry of the breast in the standard position for ultrasound imaging. For example, a value of R and θ can be determined from the transformed three-dimensional point and the known location of the nipple.

Similarly, the predicted location (e.g., R and θ values) may be used to aid in performing a physical examination of the breast. Preferably, but not necessarily, the physical examination is performed while the patient is in the standard position.

In another exemplary embodiment, the computer includes an interface at which a user may use an input device (e.g., keyboard, mouse, pointing device, etc.) to indicate the lesion of interest on one or more mammogram views, wherein the computer then outputs the expected location of the lesion for an ultrasound examination of physical examination (e.g., for a patient in the standard position). The expected location may be output as numerical coordinates, for example, displayed on the mammogram display, a computer monitor or some other display device.

In still another exemplary embodiment, the location of a lesion determined from one or more mammographic views could be displayed as a graphical overly on an image of the breast in the standard position as an aid to the sonographer. Similarly, a graphical overlay of the position or range of positions of where a lesion may be expected to be palpated on physical examination with the patient in the Standard Position could be supplied to the clinician on paper or via electronic means to facilitate the physical examination. For example, a projector could be utilized to project the graphical overlay (e.g., an “X” symbol) directly onto the breast of the patient in the standard position at the predicted location.

In still another exemplary embodiment, if the item of interest is determined by physical examination and the clinician examines the patient in the standard position and measures the coordinates of the lesion in the radial coordinates (e.g., R and θ), a graphical overlay is displayed on the site of the area of concern on the mammograms (e.g., displayed on a mammography workstation), or on a representation of the breast on the sonographer's console.

According to an exemplary embodiment, a method for correcting spatial registration anomalies between prior and subsequent congruent mammogram views, due to patient positioning and other variables, so that computer aided detection (CAD) devices can more readily compare similar mammograms, including current and prior images, to look for changes that may represent cancer to increase the sensitivity and specificity of CAD devices is provided.

For example, the CAD device could use the aforementioned lesion location process to predict a location of an item of interest in a subsequent mammogram view from the data known from the prior mammogram view. Additionally, the CAD device could spatially transform the image plane of the subsequent mammogram to account for differences in patient positioning and other variables.

According to an exemplary embodiment, a method for determining the probability that a possible lesion (marked as suspicious by CAD) seen on one mammographic view is the same structure as a possible lesion marked on another mammographic view of the same breast. Furthermore, the possible lesion indicated by the CAD could further be used to predict an expected location on ultrasound or MRI from the mammographic view or views.

According to another exemplary embodiment, a system using three-dimensional modeling and a virtual reality (VR) display teaches image interpretation and physical examination skills. As one example, a student wearing VR equipment is presented with a virtual mammogram view (e.g., a CC view of a right breast) and a corresponding virtual, three-dimensional image of the right breast. In this example, when the student selects a location on the virtual mammogram, the corresponding location on the virtual breast is predicted and an indication (e.g., an “X” symbol) is displayed on the virtual breast at the predicted location. Through repeated examples, the student learns to appreciate the spatial correlations between a two-dimensional mammogram and a three-dimensional breast.

To evaluate and establish the veracity of Applicants' general inventive concept and, in particular, the exemplary embodiments relating to the estimation of a location of an item an interest of a breast for use in performing an ultrasound, given known location information of the item from at least one and preferably two or more mammograms, the following steps were taken.

A data set of mammograms from a plurality of patients with focal mammographic abnormalities was collected. For the data set, the amount of compression used, the angle at which the image was acquired and patient data particulars (e.g., contour of the breast, breast size, etc.) were tracked. For each patient, at least one mammogram view was taken, and preferably two views were taken (e.g., typically the CC and MLO views). The mammogram data set for each patient was digitized. For each patient's data, the location of the lesion from the one or more mammogram views was determined in relation to the nipple in two-dimensional coordinates. The outer edge of the nipple was generally used as a reference point. If two views were taken, then the lesion location could be determined in three dimensional coordinates.

A data set of ultrasounds from the same set of patients, which were examined in the standard position, was also collected. From the ultrasound data set, the location of the lesion for each patient was determined in radial coordinates (R, θ, D and T), wherein R is the radius of the lesion from the nipple in centimeters; θ is the angular location of the lesion in degrees counterclockwise from the positive x-axis, which was then converted into a clock face position measured clockwise from the 12:00 position; D is the depth of the lesion from the skin surface in millimeters, and T is breast thickness in millimeters at the site of the lesion.

From the mammogram and ultrasound data sets, a representative sample of patients was selected for evaluating the algorithm. In particular, every patient having a lesion which was clearly identified in each of the CC and MLO views and in the ultrasound was selected. Accordingly, the algorithm was run on data for approximately 105 patients, which was the population size for which such complete data was available.

Applicants' general inventive concept encompasses the use of techniques (e.g., artificial intelligence, evolutionary algorithms, etc.) for parsing the mammogram and ultrasound data sets to identify relationships and parameters for use in the lesion localization process or similar algorithm.

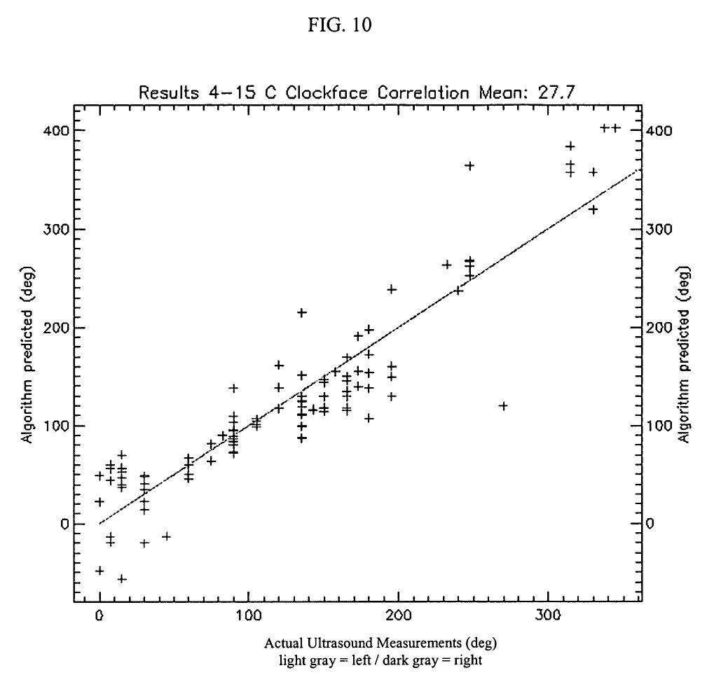

By comparing the actual ultrasound location with the location predicted based on the known mammogram locations, it was possible to observe the effectiveness of the algorithm (e.g., the lesion localization process). For example, as shown in FIG. 10, with no equipment correction methods or compression model techniques employed, the ultrasound coordinates were predicted with an absolute angular error of 27.7 degrees (i.e., less than one hour on the clock face). In FIG. 10, the straight line in the graph depicts where the predicted and the measured clock-face position are the same.

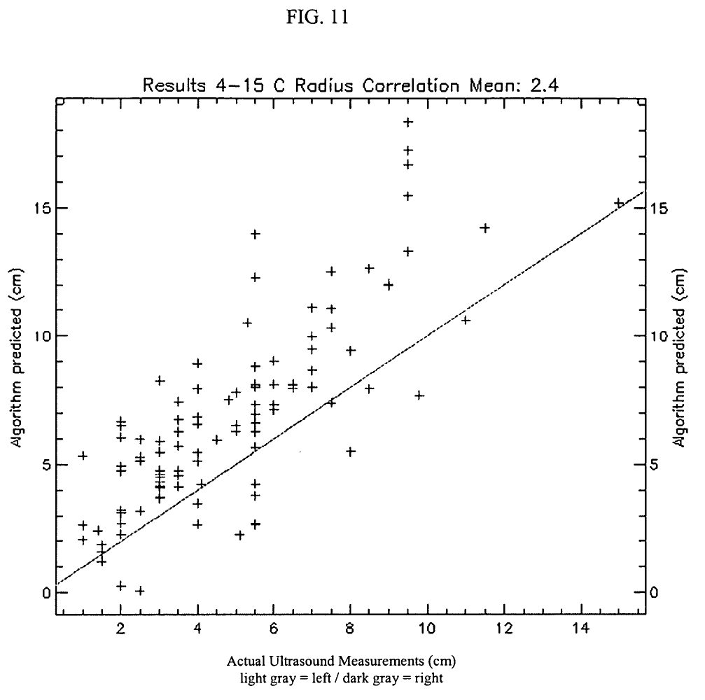

In FIG. 11, the correlation between the predicted and the measured distance from the nipple to the lesion is shown. Here, the mean radial error was 2.4 cm. In FIG. 11, the straight line in the graph depicts where the predicted and the measured distance are the same. Additionally, the absolute x-coordinate error was determined to 1.4 cm and the absolute y-coordinate error was determined to be 3.3 cm.

Exemplary embodiments have been provided herein for purposes of illustration and are not intended to in any way be limiting. Indeed, additional advantages and modifications will readily appear to those skilled in the art, without departing from the spirit and the scope of Applicants' general inventive concept. For example, while various embodiments have been described herein as using two mammogram views, Applicants' general inventive concept includes use of a single mammogram view, as well as three or more mammogram views, for predicting a location of an object of interest for another modality. As another example, while various embodiments described herein have identified locations as lines, curves, surfaces or points, the locations are not so limited and Applicants' general inventive concept includes the identification of these locations as three-dimensional regions.

We claim:

1. A method for estimating a location of an object of interest in or on a breast, the method comprising:
detecting first location information of the object of interest of the breast using a first method of evaluation; and
transforming the first location information into second location information corresponding to a second method of evaluation.

2. The method of claim 1, further comprising using the second location information to locate the object of interest using the second method of evaluation.

3. The method of claim 1, wherein the first method of evaluation is one of mammography, ultrasound, magnetic resonance imaging and physical examination.

4. The method of claim 1, wherein the second method of evaluation is at least one of mammography, ultrasound, magnetic resonance imaging and physical examination.

5. The method of claim 1, wherein at least one of the first method of evaluation and the second method of evaluation is performed on a patient in a predetermined position.

6. The method of claim 5, wherein the predetermined position includes the patient being supine and turned to a contralateral side sufficiently to flatten the breast against a chest wall of the patient.

7. The method of claim 6, wherein the predetermined position further includes the patient's arm on the same side of the breast being abducted.

8. The method of claim 7, wherein the predetermined position further includes support being placed under the arm and lateral aspect of the patient's chest, abdomen and hip.

9. The method of claim 1, wherein the object of interest is a lesion.

10. A method for estimating a location of an object of interest in or on a breast, the method comprising:
inputting data derived from a mammogram view showing the object of interest;
detecting a position of the object of interest from the data;
determining a line, a curve or a region corresponding to the position in a three-dimensional space,
wherein the line, curve or region is an estimated location of the breast in which the object of interest is located.

11. The method of claim 10, wherein determining the line, curve or region comprises backprojecting the position to the line, curve or region in the three-dimensional space.

12. The method of claim 10, further comprising outputting the estimated location.

13. The method of claim 12, wherein the estimated location is output as a three-dimensional display.

14. The method of claim 10, further comprising transforming the estimated location to the geometry of the breast in a standard position.

15. The method of claim 14, wherein the estimated location is one of a distance of the object of interest from a nipple of the breast and an angular location of the object of interest measured from a fixed origin.

16. The method of claim 15, wherein the angular location is converted to a clock face position.

17. The method of claim 10, wherein the mammogram view is one of a Cranio-Caudal view, a Mediolateral Oblique view, a Latero-Medial view, and a Mediolateral view.

18. The method of claim 10, wherein the object of interest is a lesion.

19. A method for estimating a location of an object of interest in or on a breast, the method comprising:
inputting data derived from a plurality of mammogram views showing the object of interest;
detecting a position of the object of interest in each of the plurality of mammogram views from the data;
determining a line, curve or region corresponding to each position in a three-dimensional space;
determining an intersection, or a mathematical fit to an intersection, of the lines, curves or regions,
wherein the intersection or the mathematical fit to the intersection is an estimated location of the object of interest.

20. The method of claim 19, wherein determining the line, curve or region for each position comprises backprojecting the position into the line, curve or region in the three-dimensional space.

21. The method of claim 19, further comprising outputting the estimated location.

22. The method of claim 21, wherein the estimated location is output as a three-dimensional display.

23. The method of claim 21, wherein the estimated location is visually designated on an image of a breast in a standard position.

24. The method of claim 19, further comprising transforming the estimated location to the geometry of the breast in a standard position.

25. The method of claim 19, wherein detecting the location of the object of interest in each of the plurality of mammogram views includes transforming the location to account for an angle of rotation about an axis perpendicular to a coronal plane.

26. The method of claim 19, wherein detecting the location of the object of interest in each of the plurality of mammogram views includes transforming the location to account for a tilt angle about an axis perpendicular to a sagittal plane.

27. The method of claim 19, further comprising transforming the estimated location to a plane of any orientation.

28. The method of claim 19, wherein the estimated location includes a distance of the object of interest from a nipple of the breast and an angular location of the object of interest measured from a fixed origin.

29. The method of claim 28, wherein the angular location is converted to a clock face position.

30. The method of claim 19, wherein the plurality of mammogram views includes a Cranio-Caudal view and a Mediolateral Oblique view.

31. The method of claim 19, wherein the object of interest is a lesion.

32. A method for estimating a location of an object of interest in or on a breast, the method comprising:
inputting data indicating a known position of the object of interest with respect to a fixed position on the breast; and
using the data to determine an estimated location of the object of interest in three-dimensional space,
wherein the estimated location is projected onto a plane of arbitrary orientation, position and size, the plane representing a mammogram having a specified angle of rotation, tilt angle and size.

33. The method of claim 32, wherein the plane is projected through a nipple of the breast.

34. The method of claim 32, wherein the estimated location is a region of the breast predicted to include the object of interest.

35. The method of claim 32, wherein the plane intersects a surface representing a chest wall of the breast.

36. The method of claim 35, wherein coordinates on the plane are shifted such that a left edge of the mammogram having the specified size approaches an area at which the plane and the surface intersect.

37. The method of claim 32, wherein the data is obtained from the breast in a standard position.

38. The method of claim 32, wherein the data is obtained by performing an ultrasound on the breast.

39. The method of claim 32, wherein the data is obtained by performing a physical examination on the breast.

40. The method of claim 32, wherein the data includes coordinates indicating the position of the object of interest with respect to the nipple.

41. The method of claim 40, wherein the coordinates are polar coordinates (R,θ),
wherein R is the distance of the object of interest from the nipple, and
wherein θ is the angular location of the object of interest.

42. The method of claim 41, wherein θ is measured counterclockwise from a positive x-axis of a coronal plane of the breast, with the nipple as the origin.

43. The method of claim 42, wherein θ is converted to a clock face position.

44. The method of claim 40, wherein the data further includes a depth of the object of interest from a surface of the breast.

45. The method of claim 32, further comprising outputting the estimated location.

46. The method of claim 45, wherein the estimated location is output as a graphical overlay.

47. The method of claim 32, wherein the object of interest is a lesion.

48. A method for estimating a location of an object of interest in or on a breast, the method comprising:
inputting data derived from magnetic resonance imaging of the breast;
detecting a position of the object of interest in the breast from the data; and
transforming the position to the geometry of the breast in a standard position as the estimated location of the object of interest.

49. The method of claim 48, wherein the estimated location is a region of the breast predicted to include the object of interest.

50. The method of claim 48, wherein the estimated location is used to perform at least one of an ultrasound and a physical examination.

51. A method for estimating a location of an object of interest in or on a breast, the method comprising:
inputting data derived from magnetic resonance imaging;
detecting a known position of the object of interest with respect to a fixed position on the breast; and
using the data to determine an estimated location of the object of interest in three-dimensional space,
wherein the estimated location is projected onto a plane of arbitrary orientation, position and size, the plane representing a mammogram having a specified angle of rotation, tile angle and size.

52. The method of claim 51, wherein the plane is projected through a nipple of the breast.

53. A method for estimating a location of an object of interest in or on a breast, the method comprising:
inputting data derived from magnetic resonance imaging;
detecting a known position of the object of interest with respect to a fixed position on the breast;
using the data to determine an estimated location of the object of interest in three-dimensional space; and
transforming the estimated location into the geometry of the breast in a standard position.

54. A method for estimating a location of an object of interest in or on a breast, the method comprising:
inputting data derived from a first mammogram showing the object of interest;
detecting a position of the object of interest in the first mammogram from the data;
transforming the position from the first mammogram into a line, curve or region in a three-dimensional space, the line, curve or region being an estimated region of the breast in which the object of interest is located,
projecting the line, curve or region onto a plane in the three-dimensional space, wherein the plane is projected through a fixed point of the breast and represents a second mammogram having a specified angle of rotation, tilt angle and size.

55. The method of claim 54, wherein the fixed point of the breast is a nipple of the breast.

56. The method of claim 54, wherein the method corrects spatial registration anomalies between a prior mammogram view, as the first mammogram, and a subsequent mammogram view, as the second mammogram, and wherein the first mammogram view and the second mammogram view are congruent.

57. A method for improving image interpretation and physical examination aptitude of a user, the method comprising:
(a) the user detecting first location information of an object of interest in or on a breast using a first method of evaluation; and
(b) transforming the first location information into second location information corresponding to a second method of evaluation and outputting the second location information to the user; and
(c) the user performing the second method of evaluation using the second location information.

58. The method of claim 57, wherein steps (a), (b) and (c) are repeatedly performed by the user, whereby the user improves his or her image interpretation and physical examination aptitude.

59. An apparatus for estimating a location of an object of interest in or on a breast, the apparatus comprising a circuit or a computer for detecting first location information of the object of interest of the breast using a first method of evaluation; and transforming the first location information into second location information corresponding to a second method of evaluation.

60. The apparatus of claim 59, wherein the first method of evaluation is one of mammography, ultrasound, magnetic resonance imaging and physical examination.

61. The apparatus of claim 59, wherein the second method of evaluation is at least one of mammography, ultrasound, magnetic resonance imaging and physical examination.

62. An article of manufacture comprising a computer-readable medium tangibly embodying instructions readable by a computer for performing a method of estimating a location of an object of interest in or on a breast, the method including detecting first location information of the object of interest of the breast using a first method of evaluation; and transforming the first location information into second location information corresponding to a second method of evaluation.

63. The article of manufacture of claim 62, wherein the first method of evaluation is one of mammography, ultrasound, magnetic resonance imaging and physical examination.

64. The article of manufacture of claim 62, wherein the second method of evaluation is at least one of mammography, ultrasound, magnetic resonance imaging and physical examination.
